(19) United States
(12) Patent Application Publication
(10) Pub. No.: US 2017/0297804 A1
(43) Pub. Date: Oct. 19, 2017

(54) Hygienic Handling of Infant Formula Containers

(71) Applicant: Mead Johnson Nutrition Company, Glenview, IL (US)

(72) Inventor: Margo E. Love, Evansville, IN (US)

(21) Appl. No.: 15/099,225

(22) Filed: Apr. 14, 2016

(51) Int. Cl. B65D 81/28; B65D 25/36; A01N 59/16; A47J 47/04; B65D 51/24; B65D 43/16

(52) U.S. Cl. CPC B65D 81/28; B65D 51/247; B65D 43/169; A01N 59/16; A47J 47/04; B65D 25/36

(57) ABSTRACT

A closure and dispensing system for a container storing granulated powder that includes a closure comprising a collar and a lid, and a measuring utensil. An anti-bacterial food-grade additive can be coated on these components of the dispensing system or incorporated into the material of manufacture. The anti-microbial additive can include silver ions incorporated in the plastic resin or incorporated into a lacquer. The lid can be formed with a utensil retainer that can include an anti-microbial agent incorporated into its material of manufacture or coated onto its surface. The measuring utensil can be stored inside the closure and used to dispense granulated powder from the container.

### TECHNICAL FIELD

The present disclosure relates to containers, measuring utensils and closures having antimicrobial properties. More particularly, the disclosure relates to containers, closures and dispensing utensils for powdered nutritional supplements and food concentrates with anti-microbial properties.

### BACKGROUND

Hygiene can be important, particularly when preparing foods to be consumed by infants. Concern for hygiene can extend beyond the food being prepared for consumption to include containers and utensils that may contact the food during preparation and storage. Some foods, such as powdered or particulate nutritional supplements, such as infant formula, can provide favorable sites for microbial growth. Infants, and other vulnerable consumers of powdered nutritional supplements, can be susceptible to illnesses caused by consuming microbe-contaminated supplements in which the microbes have been permitted to grow.

Manufacturers and vendors frequently sell these powdered supplements in containers with removable lids and utensils designed to be stored in the containers together with the product. These convenient containers permit users to repeatedly and conveniently retrieve and dispense measured quantities of the product. Conventionally, users remove the lids and use the provided utensils to retrieve and dispense product, replacing the utensils and reclosing the lids after each use. Each use provides an opportunity for microbial contaminants to enter the container either falling directly into the product, or via cross contamination of the utensil, which may be deposited into the remaining product or stored elsewhere in the container, such as in the lid.

After a user repeatedly accesses and dispenses product from these containers, the product may become contaminated with microbes from the user's hands and other microbes that enter the container while it is opened. Over time, the contaminating microbes can grow significantly, creating potential health hazards. Some users, manufacturers and vendors have attempted to reduce the threat posed by microbial growth by various methods such as improving hand cleansing and other hygiene practices, and storing dispensing utensils separately from the product, so that any contaminants on utensil handles have little opportunity to grow in the product during storage. However, some improved hygiene practices cannot readily be implemented in all situations and storing utensils in a separate compartment, even if in a separate pouch within container can lead to additional expense. Accordingly, there exists a need for containers, associated container closures and utensils with improved ability to hinder the growth of surface microbes, such as bacteria and fungi that could otherwise be transferred into infants via food containers.

### BRIEF SUMMARY

In one embodiment, a container for particulate nutritional compositions includes a tub having a bottom and a sidewall defining an interior. The tub includes an open top and a lid connected to the tub that is configured to close the open top of the tub. The container also includes a utensil configured to scoop particulate nutritional composition from the tub. At least one of the tub, the lid and the utensil can include an anti-microbial agent. The anti-microbial agent can be included in the container's utensil, the lid, or the tub. Optionally, the anti-microbial agent is mixed into the plastic resin of the component or coated on the component. The anti-microbial agent can be a silver ion composite and, optionally, the anti-microbial agent can be silver nitrate.

According to another option, the tub can include a plastic material coated with a lacquer, the lacquer including the anti-microbial agent. Alternatively, the tub can include a metal coated with a lacquer wherein the lacquer includes the anti-microbial agent. In yet a further alternative, the tub can include a film attached to an external surface of the tub, and the film can include an anti-microbial agent.

According to a further option, the lid of the container can include a retainer for holding the utensil in the interior of the tub. The retainer can include the anti-microbial agent.

In another embodiment, a container for particulate nutritional compositions includes a tub having a bottom and a sidewall defining an interior and an open top. A lid is connected to the tub and is configured to close the open top of the tub. Also, the container includes a utensil configured to scoop particulate nutritional composition from the tub. The utensil includes an anti-microbial agent to reduce bacterial contamination of the particulate nutritional composition upon use of the utensil. Optionally, the container's lid can include an anti-microbial agent to reduce bacterial contamination of the particulate nutritional composition. The container's tub can also include an anti-microbial agent to reduce bacterial contamination of the particulate nutritional composition. As a further alternative, the tub can further include an external coating of an anti-microbial component, or a film including an anti-microbial component attached to an external surface of the tub. The anti-microbial agent is a silver ion composite. Optionally, the anti-microbial agent can include silver nitrate.

### BRIEF DESCRIPTION OF THE DRAWINGS

A full and enabling disclosure, including the best mode thereof directed to one of ordinary skill in the art, is set forth in the specification, which refers to the appended figures, in which:

FIG. 1 is a perspective view of a portion of a container in accordance with one embodiment of the present disclosure.

FIG. 2 is a cross sectional view of a container closure according to one embodiment of the present invention.

FIG. 3 is a perspective view of the closure of FIG. 2.

FIG. 4 is a detailed perspective view of the closure of FIG. 2.

FIG. 5 is a perspective view of a container according to an alternative embodiment of the present disclosure.

FIG. 6 is a perspective view of a utensil according to one embodiment of the present disclosure.

FIG. 7 is a perspective view of a lid according to one embodiment of the present disclosure.

FIG. 8A is a cross sectional view of an embodiment of the utensil of FIG. 6.

FIG. 8B is a cross sectional view of an alternative embodiment of the utensil of FIG. 6.

FIG. 9A is a cross sectional view of an embodiment of the lid of FIG. 7.

FIG. 9B is a cross sectional view of an alternative embodiment of the lid of FIG. 7.

FIG. 10A is a cross sectional view of an embodiment of the clip of FIG. 7.

FIG. 10B is a cross sectional view of an alternative embodiment of the clip of FIG. 7.

Repeated use of reference characters in the present specification and drawings is intended to represent same or analogous features or elements of the disclosure.

### DETAILED DESCRIPTION

Reference now will be made in detail to the embodiments of the present disclosure, one or more examples of which are set forth herein below. Each example is provided by way of explanation of the container of the present disclosure and is not a limitation. In fact, it will be apparent to those skilled in the art that various modifications and variations can be made to the teachings of the present disclosure without departing from the scope or spirit of the disclosure. For instance, features illustrated or described as part of one embodiment, can be used with another embodiment to yield a still further embodiment.

Thus, it is intended that the present disclosure covers such modifications and variations as come within the scope of the appended claims and their equivalents. Other objects, features and aspects of the present disclosure are disclosed in or are obvious from the following detailed description. It is to be understood by one of ordinary skill in the art that the present discussion is a description of exemplary embodiments only and is not intended as limiting the broader aspects of the present disclosure.

All references to singular characteristics or limitations of the present disclosure shall include the corresponding plural characteristic or limitation, and vice versa, unless otherwise specified or clearly implied to the contrary by the context in which the reference is made.

For the sake of clarity, not all reference numerals are necessarily present in each drawing Figure. In addition, positional terms such as “upper,” “lower,” “side,” “top,” “bottom,” “vertical,” “horizontal,” etc. refer to the container when in the orientation shown in the drawings. The skilled artisan will recognize that containers can assume different orientations when in use.

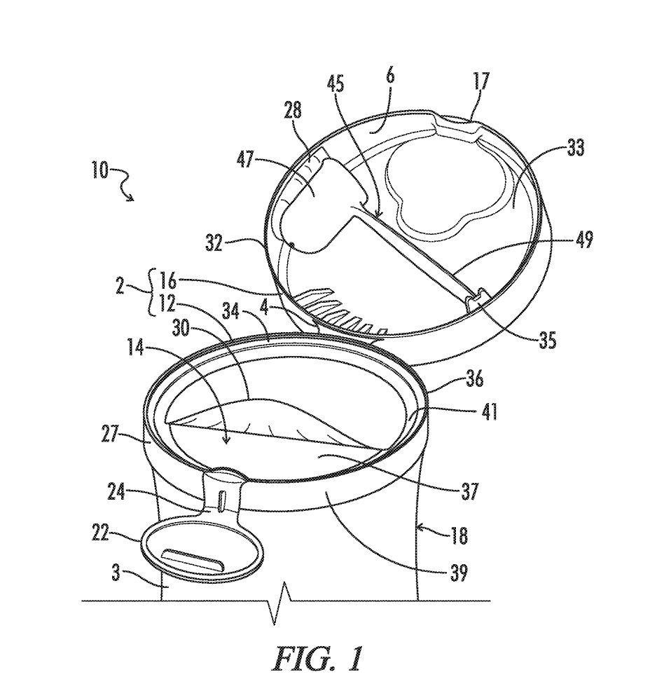

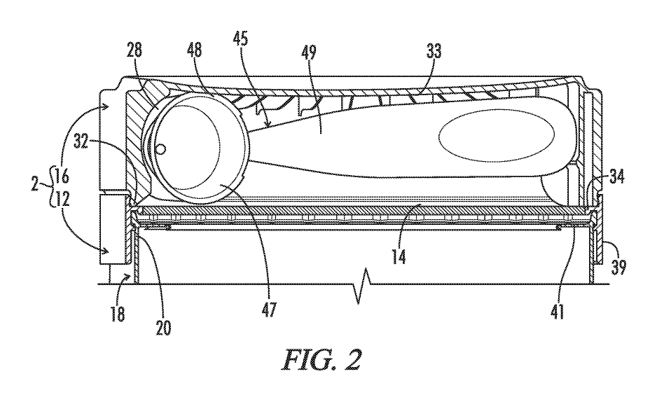

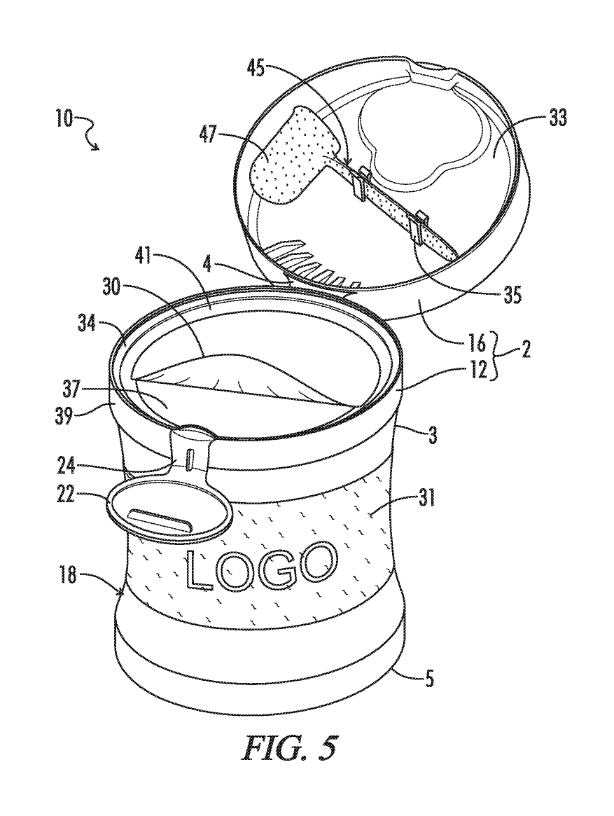

A perspective view of an embodiment of a container 10 of the present invention is shown in FIG. 1 for storing a particulate nutritional composition, or particulate product, such as powdered milk or infant formula. In the illustrated embodiment, container 10 includes a tub 18 and a closure 2 having a lid 16 pivotably attached to a collar 12. Tub 18 includes a sidewall 3 that defines an interior volume. Tub 18 further includes a generally planar base wall or bottom 5 (shown in FIG. 5) to form a closed bottom end of tub 18. Sidewall 3 extends upward from the base wall to a neck 20 (shown in FIG. 2) defining an open top of tub 18. The base wall 5 and sidewall 3 of tub 18 are configured to permit container 10 to conveniently and stably rest on commonly used surfaces where container 10 may be placed, such as storage shelves and tables.

Although tub 18 shown in FIG. 1 is generally cylindrical with a circular cross-section for purposes of illustration, it will be understood that other shapes may be suitable, depending on the desired design of the container 10, to include containers 10 with multiple, generally planar sidewalls joined to form a polygonal shape, as well as containers 10 having sidewalls with various curvilinear shapes.

Closure 2 is attached at the open top end of tub 18 and is intended for use in closing or securing the opening of tub 18 to form an upper boundary of the interior volume of tub 18. Closure 2 is illustrated in FIG. 1 as a unitary, one-piece structure having a collar 12 mounted around the or open top of tub 18, and a lid 16 connected to collar 12 via a hinge 4, which can be a living hinge of the same material as lid 16 and collar 12. If hinge 4 is a living hinge, in can preferably be formed to be flexible allowing lid 16 to pivot about the hinge with respect to collar 12. In alternative embodiments, the closure 2 can be a multi-piece structure in which one or more of the hinge 4, collar 12 and lid 16 are formed separately and, optionally, made different materials. In such cases, hinge 4 can be of any commonly known, suitable design and, for example, can comprise two or more wing members coupled along one side to rotate, or pivot, about a pin or shaft that holds the wings together. Opposite sides of the wings can be attached to the lid 16 and collar 12, permitting them to articulate.

Tub 18 includes a mouth 37, defined by an inner flange 41 that extends inwardly near the open top of sidewall 3 to form a rim around the perimeter of opening 14. Collar 12 includes an opening 14 so that when collar 12 is mounted on tub 18, the opening 14 generally coincides with mouth 37 of the tub 18 so that the contents of tub 18 can be dispensed through the mouth 37 and the opening 14 when lid 16 is open.

Collar 12 includes a circumferential edge 36. The circumferential edge 36 can be generally circular. However, alternate configurations may be adopted as necessary for collar 12 to conform to the shape of mouth 37 of tub 18 as well as to engage lid 16. A cylindrical skirt 39 defines the circumferential edge 36 of collar 12 to releasably engage and seal around neck 20 and the open top of tub 18. In some embodiments, the skirt 39 can threadably engage tub 18. Skirt 39 can further include internal screw threads that operatively engage complementary screw threads on the neck 20 of tub 18. In other embodiments, alternate engaging means can be used, to provide press-on or snap-on attachment, for example.

According to other embodiments, the tub 18 and the closure 2 can be formed as a single unit so that the collar 16 is an integral part of the neck 20 of sidewall 3. Alternatively, closure 2 can be removably attached to tub 18, as described above. The outer surface 27 of the skirt 39 can be smooth. Still, in other alternative embodiments, the outer surface 27 of the skirt 39 can include a plurality of notches, ridges or other textures to improve a user's ability to grip and hold closure 2. Additional grip may be useful, for example, when removing closure 2 from tub 18.

Lid 16 is hingedly attached to collar 12 via lid hinge 4, so that lid 16 can pivot relative to collar 12 and move between a closed position, which seals lid 16 across opening 14, and an unsealed open position, which permits users to access the contents of container 10 located in interior volume of container 10.

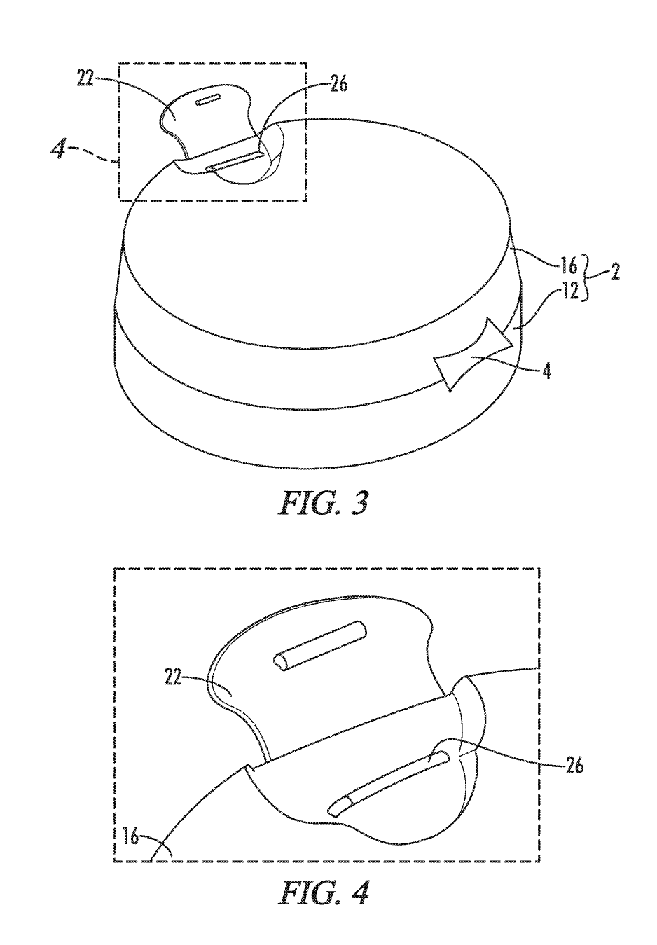

Closure 2 may also include latch 22, which can be any suitable latch known in the art for releasably attaching lid 16 to collar 12 in a closed position. In the embodiment shown in Figs.1-5, latch 22 is hingedly attached to collar 12 and pivots to engage lid catch 26 to hold lid 16 closed against collar 12. Latch 22 and catch 26 are preferably near the front side 17 of lid 16 and located on an outer surface 27 of collar 12. In some embodiments, latch 22 is pivotably attached to collar 12 via a latch hinge 24, so that collar 12 and collar latch 22 can be manufactured as one integral piece. Having collar 12 and collar latch 22 pivotally attached via latch hinge 24 can reduce the time associated with assembling closure 2 during manufacture. In such instances, latch 22 can avoid a secondary manufacturing step that might otherwise be necessary to connect latch 22 to collar 12 after being formed.

In embodiments where tub 18 stores granular or particulate product that can become stale with time, such as infant formula or food products, tub 18 can include a freshness seal 30 removably attached to mouth 37. The freshness seal 30 can be heat-sealed, or otherwise attached, across mouth 37 of tub 18 during the manufacturing process and remain on tub 18 during distribution and storage until opened by a consumer, prior to the first use of the product. For example, freshness seal 30 can be sealingly attached to flange 41. Freshness seal 30 operates to prevent staling or to otherwise preserve palatability of the contents of tub 18. Freshness seal 30 also helps to maintain the integrity of the container contents by serving as both a protective barrier preventing contaminants from reaching the product during shipping and as a tamper evident mechanism indicating to a consumer that the contents of the container may have been previously accessed or manipulated.

In embodiments that include freshness seal 30, collar 12 can be connected to mouth 37 of tub 18 so that freshness seal 30 is located between collar 12 and mouth 37 of tub 18. Freshness seal 30 can then be removed by the consumer by pulling freshness seal 30 up through opening 14 in collar 12, thereby giving the consumer access to the contents of tub 18.

Lid 16 can have a lower edge 32 that closes against a lid mating surface 34 of collar 12 when lid 16 is in a closed position. In FIG. 1, lid mating surface 34 extends laterally inward generally from circumferential edge 36 of collar 12. As such, lower edge 32 of lid 16 can be positioned laterally inward from circumferential edge 36 of collar 12. It will be readily apparent to one of skill in the art that lid mating surface 34 of collar 12 can extend laterally outward from circumferential edge 36 such that lower edge 32 of lid 16 is positioned laterally outward from circumferential edge 36 when lid 16 is in the closed position. In a closed position, lower edge 32 engages collar 12 so that lower edge 32 is in contact with lid mating surface 34 on collar 12. FIG. 2 best shows this in a cross-sectional view of closure 2 with lid 16 in a closed position and collar 12 mounted on tub 18.

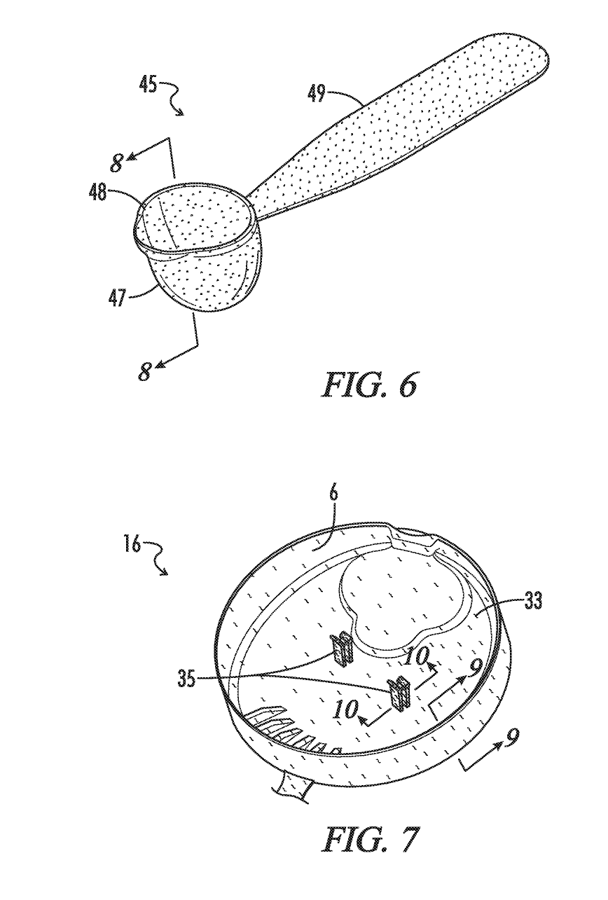

Lid 16 can also include a utensil retainer that can receive and hold a measuring utensil 45 for storage in lid 16. Utensil 45 can be a scoop having a handle 49 and a bowl 47. As shown in FIGS. 2 and 6, bowl 47 can have a generally circular bowl perimeter 48. But it will be understood that other scoop shapes can be used. For instance, bowl perimeter 48 can be substantially rectangular, oblong, or elliptical, and bowl 47or can be cuboid, cylindrical, or ellipsoid, or otherwise shaped as is known to facilitate scooping, dispensing or design requirements of utensil 45.

The utensil retainer can include groves or recesses in lid 16, such as notch 28. The utensil retainer can also include lugs, fingers or clips 35 that can be closely spaced and extend from lid underside 33 or from an inner perimeter surface 6 of lid 16 to help grip a portion of utensil 45 received between them. It will be understood that the combination of notches 28 and clips 35 can be configured, as well known in the art, to releasably grip or hold utensil 45 so that a user can store the utensil 45 in lid 16 and conveniently retrieve it when needed to scoop and dispense the particulate product from container 10. Preferably retainer 35 can hold utensil 45 inside closure 2 in the space between lid underside 33 and the plane of lower edge 32, so that utensil 45 remains separate from the particulate product when container 10 is in a near upright position. With utensil 45 stored in this location, users can conveniently retrieve it without reaching into the bulk of the stored particulate material in tub 18 and can thus avoid contaminating the stored particulate product with dirt, bacteria and other microbes that may be on the user's hands. FIG. 1 utensil 45 releasably held in lid 16 by notch 28 and clip 35 according to one utensil retainer arrangement. FIG. 5 shows utensil 45 releasably held in lid 16 by clips 35 according to an alternative utensil retainer arrangement.

Bottom 5 and sidewall 3 of tub 18 can be constructed of materials commonly used in similar containers for storing particulate nutritional compositions, such as sheet metal or polymers. Suitable polymers, for example, can include polypropylene, high density polyethylene, low density polyethylene, polystyrene, polystyrene-acrylonitile, acrylonitile-butadiene-styrene, styrene-maleicanhydride, polycarbonate, polyethylene terephthalate, polyvinylcyclohexane, and blends thereof. As is also known, tub 18 may also be constructed from paper, cardboard, or another fibrous material, optionally coated with a plastic material or foil laminate. Similarly, the container could be constructed from a flexible film, thereby providing a flexible pouch.

Closure 2 can also be formed of a polymeric resin material. Suitable polymeric materials for forming each of the components of the closure include high density polyethylene, low density polyethylene, ultra high molecular weight polyethylene, polypropylene, polycarbonate, acrylic, polyvinyl chloride (“PVC”), flexible polyvinyl chloride (“FPVC”), polyurethene, ABS, nylon or polyester, or blends thereof. In some embodiments, the polymeric resin material used for forming the closure 2 may comprise an inorganic antimicrobial agent.

Various components of container 10, such as closure 2, tub 18 and utensil 45 preferably include an antimicrobial agent to prevent contamination or growth or harmful microbes of the particulate product dispensed from container 10. The anti-microbial can be an anti-microbial agent that protects against varying strains of the most common organisms, including pathogenic bacteria, black mold fungi, saprophytic yeast, gram negative, pathogenic bacteria, nosocomial bacteria, facultative anaerobic gram negative bacillus, aerobic gram negative bacillus, gram positive non-spore-forming bacillus, aerobic gram positive coccus, saprophytic fungi, combinations thereof, and the like. Particular strains include Acinetobacter baumannii, Aspergillus niger, Candida albicans, Campylobacter, Enterococcus faecalis, Enterobacter aerogenes, Extended spectrum beta lactamases (ESBL), Escherichia coli, Klebsiella pneumonia, Legionella, Listeria monocytogenes, Methicillin Resistant Staphylococcus Aureus (MRSA), Proteus vulgaris, Pseudomonas aeruginosa, Salmonella enteritidis, Salmonella typhimurium, Trychophyton mentagrophytes, Vancomycin resistant enterococci (VRE), combinations thereof, and the like, such as Cronobacter sakazakii.

An anti-microbial agent can include a number of metal ions exhibiting fungicidal, bactericidal or bacteriostatic activity such as silver, copper, zinc, mercury, tin, lead, bismuth, cadmium, chromium and thallium ions. Without being bound by a particular theory, these antimicrobial metal ions are believed to exert their effects by binding to the cell walls of bacteria and disrupting respiration and electron transport systems upon absorption into the cells. The agent may also interfere with enzyme production stopping the bacterial cell from producing energy. In some aspects, the agent interrupts the bacterial cells' DNA preventing replication. Antimicrobial metal ions of silver, gold, copper and zinc, in particular, are considered safe even for use with nutritional compositions such as infant formulas and children's products. Antimicrobial silver ions are particularly safe for use infant formulas and children's products because they are not substantially absorbed into the body. Accordingly, if such materials are used they should not be hazardous.

In at least one embodiment of the invention, the inorganic antibiotic metal containing composition is an antibiotic metal salt. Such salts include silver acetate, silver benzoate, silver carbonate, silver ionate, silver iodide, silver lactate, silver laureate, silver nitrate, silver oxide, silver palpitate, silver protein, and silver sulfadiazine. Silver nitrate is preferred. Salts of silver are beneficial because they are non-leaching. Accordingly, once it is incorporated into the plastic resin it does not seep out of the resin. Further, the controlled release of the active ingredient, the silver ions, provides antimicrobial protection for the life of the container and its components.

The anti-microbial component can advantageously be included in those surfaces of container 10 that contact the particulate product or that a user might contact while scooping or otherwise dispensing the particulate product. Thus interior surfaces of tub 18, lid 16 and utensil bowl 47 can advantageously include anti-microbial agent. But in addition to these surfaces, particulate product can inadvertently come into contact with other surfaces, such as handle 49 and also outer surfaces of container 10. For example particulate product can contact a user's hands during the dispensing process. If the user subsequently touches outer surfaces of tub 18 or lid 16, these too may become contaminated with nutritional product. The nutritional product in these locations can provide sites for additional bacterial growth and can cross contaminate remaining particulate product stored in container 10 or surfaces of utensil 45 when the user next opens container 10 to retrieve and dispense product.

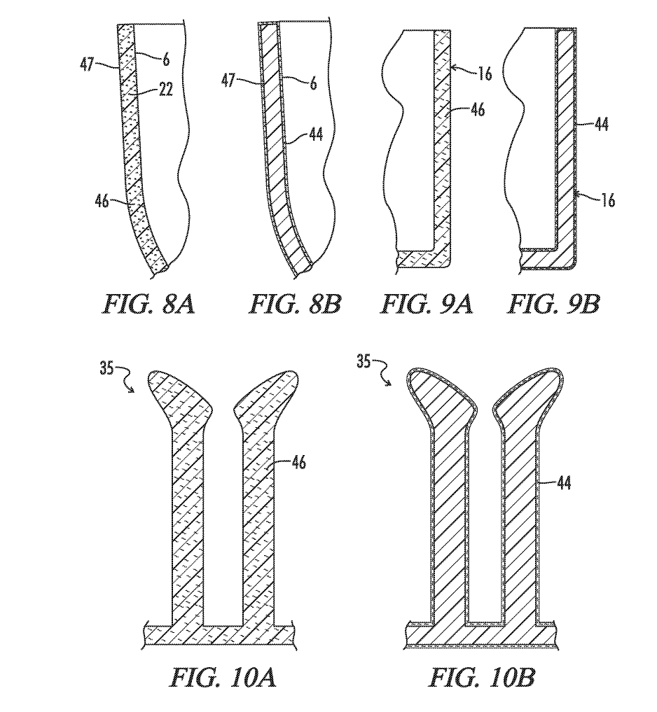

Anti-microbial agent can be incorporated into surfaces of container 10 in several ways. For example, where tub 18, closure 2 or utensil 45 is formed from a polymer that extends to the relevant surfaces of any one of these articles, the anti-microbial agent can be incorporated into the article's polymer resin prior to forming the article. Alternatively, the anti-microbial agent can be coated onto the surface of the article using conventional methods. FIG. 6 shows utensil 45 with anti-microbial agent (depicted by dots) incorporated into its polymer resin or coated onto its surfaces. FIG. 8A shows a cross-section of utensil bowl 47 incorporating anti-microbial agent in the polymer resin of utensil 45 as polymer/anti-microbial blend 46. FIG. 8B shows a cross-section of utensil bowl 47 with anti-microbial agent incorporated as a coating 44 on the surface of utensil 45. FIG. 7 shows lid 16 incorporating anti-microbial agent (shown with curly dashes) mixed into the polymer resin of lid 16. FIGS. 9A and 10A respectively show cross-sections of a side of lid 16 and clip 35 formed from a polymer and anti-microbial blend 46. FIGS. 9B and 10B respectively show cross-sections of a side of lid 16 and clip 35 with an anti-microbial coating 44. The coating 44 can have a thickness of 1 μm to 7 μm, and in particular in the range from 2 μm to 4 μm.

In embodiments where components, such as tub 18, are formed from sheet metal, or where it is otherwise undesirable to incorporate anti-microbial agent into a polymer resin, anti-microbial agent can be incorporated into a lacquer that is coated onto the component. As yet another alternative, the anti-microbial agent can be incorporated into a label or other product wrapping layer that can be wrapped around desired portions of container 10. FIG. 5, for example, shows one embodiment in which label 31 incorporates anti-microbial agent either incorporated into the label material or coated on its surface. Label 31 can be made of any known suitable material, such as a film of a polymer or a fibrous material film such as paper.

The product contained within the container may be any product known in the art. In some embodiments, the product is in a form selected from a liquid, ready-to-use product, liquid concentrate, fluid, powder, suspension, emulsion, or combination thereof. In some embodiments, the product contained within the container is a food or drink product. In a particular embodiment, the product contained within the container is a food, food concentrate, or a nutritional supplement for children or adults.

All references cited in this specification, including without limitation, all papers, publications, patents, patent applications, presentations, texts, reports, manuscripts, brochures, books, internet postings, journal articles, periodicals, and the like, are hereby incorporated by reference into this specification in their entireties. The discussion of the references herein is intended merely to summarize the assertions made by their authors and no admission is made that any reference constitutes prior art. Applicants reserve the right to challenge the accuracy and pertinence of the cited references.

Although embodiments of the disclosure have been described using specific terms, devices, and methods, such description is for illustrative purposes only. The words used are words of description rather than of limitation. It is to be understood that changes and variations may be made by those of ordinary skill in the art without departing from the spirit or the scope of the present disclosure, which is set forth in the following claims. In addition, it should be understood that aspects of the various embodiments may be interchanged in whole or in part. For example, while methods for the production of a commercially sterile liquid nutritional supplement made according to those methods have been exemplified, other uses are contemplated. Therefore, the spirit and scope of the appended claims should not be limited to the description of the versions contained therein.

What is claimed is:

1. A container for particulate nutritional compositions, comprising:
a tub having a bottom and a sidewall defining an interior and an open top;
a lid connected to the tub and configured to close the open top of the tub; and
a utensil configured to scoop particulate nutritional composition from the tub, at least one of the tub, the lid and the scoop including an anti-microbial agent.

2. The container of claim 1, wherein the utensil includes the anti-microbial agent.

3. The container of claim 1, wherein the lid includes the anti-microbial agent.

4. The container of claim 1, wherein the tub includes the anti-microbial agent.

5. The container of claim 1, wherein the anti-microbial agent is mixed into the plastic resin of the component.

6. The container of claim 1, wherein the anti-microbial agent is coated on the component.

7. The container of claim 1, wherein the anti-microbial agent is a silver ion composite.

8. The container of claim 1, wherein the anti-microbial agent is a silver nitrate.

9. The container of claim 1, wherein the tub comprises a plastic coated with a lacquer that includes the anti-microbial agent.

10. The container of claim 1, wherein the tub comprises a metal coated with a lacquer that includes the anti-microbial agent.

11. The container of claim 1, wherein the tub includes a film attached to an external surface of the tub, the film including an anti-microbial agent.

12. The container of claim 1, wherein the lid includes a retainer for holding the utensil in the interior of the tub.

13. The container of claim 12, wherein the retainer includes the anti-microbial agent.

14. A container for particulate nutritional compositions, comprising:
a tub having a bottom and a sidewall defining an interior and an open top;
a lid connected to the tub and configured to close the open top of the tub; and
a utensil configured to scoop particulate nutritional composition from the tub, the utensil including an anti-microbial agent to reduce microbial contamination of the particulate nutritional composition upon use of the utensil.

15. The container of claim 14, wherein the lid includes an anti-microbial agent to reduce microbial contamination of the particulate nutritional composition.

16. The container of claim 14, wherein the tub includes an anti-microbial agent to reduce microbial contamination of the particulate nutritional composition.

17. The container of claim 14, wherein the tub includes an external coating of an anti-microbial component.

18. The container of claim 14, further comprising a film including an anti-microbial component, the film attached to an external surface of the tub.

19. The container of claim 14, wherein the anti-microbial agent is a silver ion composite.

20. The container of claim 14, wherein the anti-microbial agent includes silver nitrate.
